(19) United States
(12) Patent Application Publication
(10) Pub. No.: US 2015/0006130 A1
(43) Pub. Date: Jan. 1, 2015

(54) HANDHELD DEVICE AND METHOD FOR SIMULATING MOVEMENT TRACK OF VEHICLE USING THE HANDHELD DEVICE

(71) Applicant: HON HAI PRECISION INDUSTRY CO., LTD., New Taipei (TW)

(72) Inventor: CHIH-YUAH TSAI, New Taipei (TW)

(21) Appl. No.: 14/314,541

(22) Filed: Jun. 25, 2014

(30) Foreign Application Priority Data
Jun. 27, 2013 (TW) 102122898

(51) Int. Cl. G06F 17/50

(52) U.S. Cl. CPC G06F 17/5009
USPC 703/2; 703/8

(57) ABSTRACT

A method for simulating a movement Track of a vehicle for a vehicle using a handheld device requires a first senor and a second sensor. The method detects three-axis acceleration variations of the vehicle using the first sensor when the vehicle is moving. When at least one of the detected three-axis acceleration variations is greater than a preset threshold, a movement speed of the vehicle is detected using a position system and three-axis angle variations are detected using the second sensor. The method further stores the detected movement speeds and detected three-axis angle variations as vehicle data into a storage device. When the vehicle stops moving, the method stops storing the detected movement speeds and detected three-axis angle variations when and simulate a movement Track according the vehicle data stored in the storage device.

### CROSS-REFERENCE TO RELATED APPLICATIONS

This application claims priority to Taiwanese Patent Application No. 102122898 filed on Jun. 27, 2013 in the Taiwan Intellectual Property Office, the contents of which are incorporated by reference herein.

### FIELD

Embodiments of the present disclosure relate to driving simulation and particularly to a handheld device and method for simulating a movement Track of a vehicle using the handheld device.

### BACKGROUND

A tachograph is a device installed on a vehicle to automatically record and store images of a driving process of the vehicle. Generally, the tachograph needs to individually connect to one part inside of the vehicle. If there are other electronic devices (for example, a music player and a position device), connecting circuits a plurality of different electronic devices in the vehicle may become complicated. Furthermore, some tachographs may simultaneously record road conditions both at the front and at the back of the vehicle. The road conditions at other directions of the vehicle (for example, a dead angle at one side of the vehicle) cannot be captured.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of a handheld device including a vehicle track simulation system.

FIG. 2 is an diagrammatic view of an embodiment of fixing the handheld device onto a fixed structure of a vehicle.

FIG. 3 is an diagrammatic view of an embodiment of coordinate axes of coordinate systems of a first sensor and a second sensor in the handheld device of FIG. 1.

FIG. 4 is an diagrammatic view of an embodiment of an indicating direction of each axes when the vehicle is motionless.

FIG. 5 is a block diagram of one embodiment of function modules of the vehicle track simulation system of the handheld device in FIG. 1.

FIG. 6 is a flowchart of one embodiment of a method for simulating a movement Track of a vehicle appearing on the handheld device of FIG. 1.

FIG. 7 is a diagram of an embodiment of changes of acceleration variation along a Z-axis when the back of the vehicle is impacted.

FIG. 8 is a diagram of an embodiment of changes of acceleration variation along a Z-axis when the front of the vehicle is impacted.

FIG. 9 is a diagrammatic view of an embodiment of deflection angles after the vehicle is impacted.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.”

In the present disclosure, “module” refers to logic embodied in hardware or firmware, or to a collection of software instructions, written in a program language. In one embodiment, the program language can be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

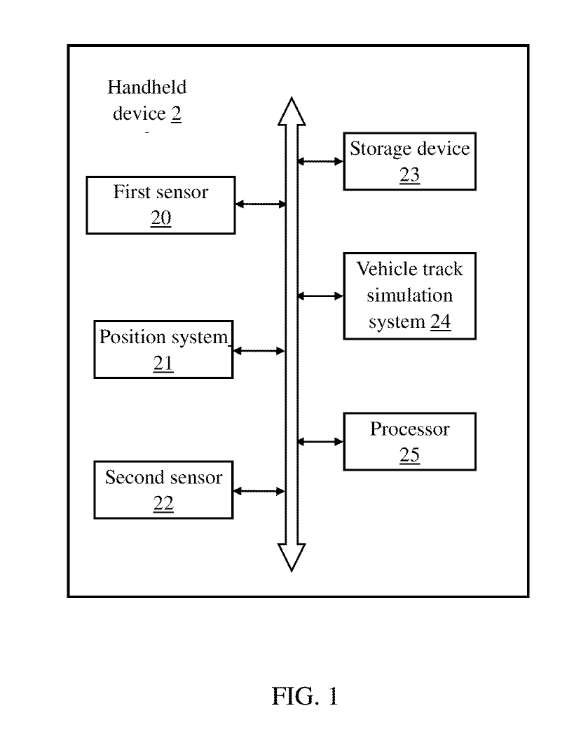

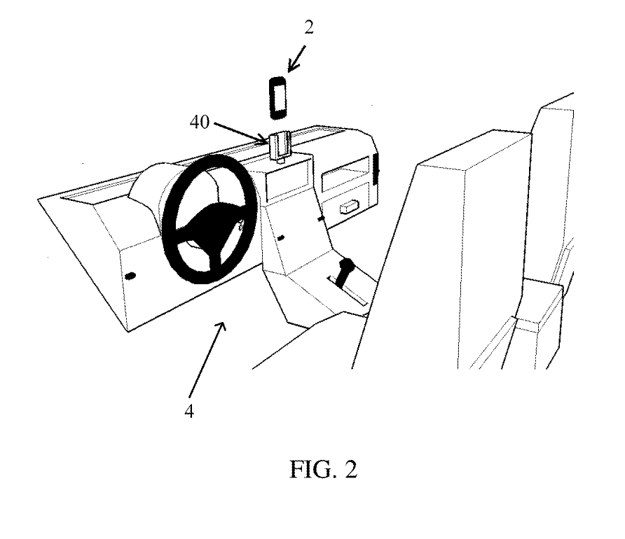

FIG. 1 is a block diagram of one embodiment of a handheld device 2 including a vehicle track simulation system 24. In one embodiment, the handheld device 2 can be a smart phone, a tablet computer, or any other handheld device. The handheld device 2 further includes, but is not limited to, a first sensor 20, a position system 21, a second sensor 22, a storage device 23, and at least one processor 25. As shown in FIG. 2, the handheld device 2 is positioned inside of a vehicle 4, for example, the handheld device 2 is fixed by a fixed structure 40 (e.g. a bracket).

In one embodiment, the first sensor 20 can be a two-axis accelerometer or a three-axis accelerometer that detects three-axis acceleration variations of the vehicle 4, such as the three-axis acceleration variations “Ax”, “Ay”, and “Az” respectively along an X-axis, a Y-axis, and a Z-axis of a preset coordinate system of the handheld device 2. The position system 21 can be a global positioning system (GPS) that detects position information (e.g. longitude and latitude) and a movement speed “Gv” of the vehicle 4 when the vehicle 4 is moving. The second sensor 22 can be a space gyroscope that detects three-axis angle variations “Gx”, “Gy”, and “Gz” along the X-axis, the Y-axis, and the Z-axis.

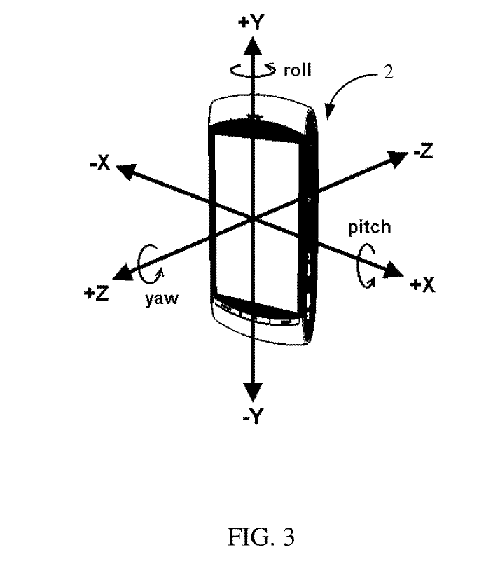

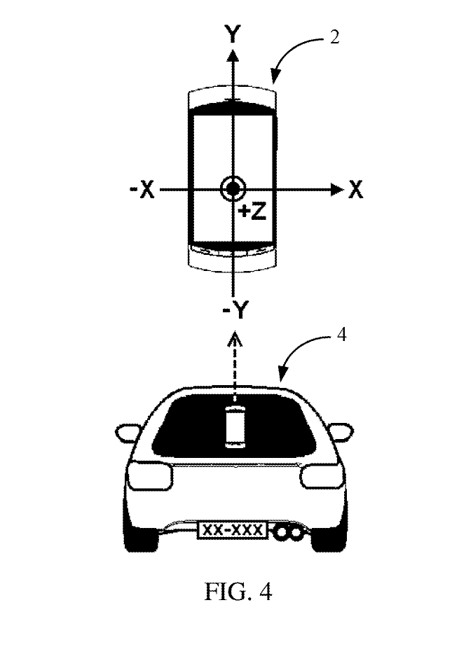

Axes of the first sensor 20 and a second sensor 22 in the handheld device 2 are shown in FIG. 3. When the handheld device 2 is fixed vertically in the vehicle 4, a positive orientation along the Z-axis “+Z” represents a vertical direction of a display of the handheld device 2 toward the inside of the vehicle 4, and a negative orientation along the Z-axis “−Z” represents a vertical direction of the display toward the outside of the vehicle 4. A positive orientation along the Y-axis “+Y” represents a direction perpendicular to the display toward the top of the vehicle 4, and a negative orientation along the Y-axis “−Y” represents a direction perpendicular to the display toward the bottom of the vehicle 4. A horizontal direction of the display of the handheld device 4 is defined as the X-axis. FIG. 4 shows an diagrammatic view of an embodiment of each axis when the vehicle 4 is motionless. When the vehicle 4 is motionless, the handheld device 2 is determined to be in an initial state.

In one embodiment, the vehicle track simulation system 24 can detect a movement state of the vehicle 4 using the first sensor 20. When the vehicle 4 is determined to be crashed, the vehicle track simulation system 24 can detect and store movement speeds and movement directions of the vehicle using the second sensor 22 until the vehicle 4 stops moving. The vehicle track simulation system 24 can simulate a movement Track of the vehicle 4 according to the stored data.

The at least one processor 25 executes one or more computerized codes and other applications of the handheld device 2 to provide functions of the vehicle track simulation system 24. The storage device 23 can be a memory of the handheld device 2 or an external storage card, such as a smart media card or a secure digital card.

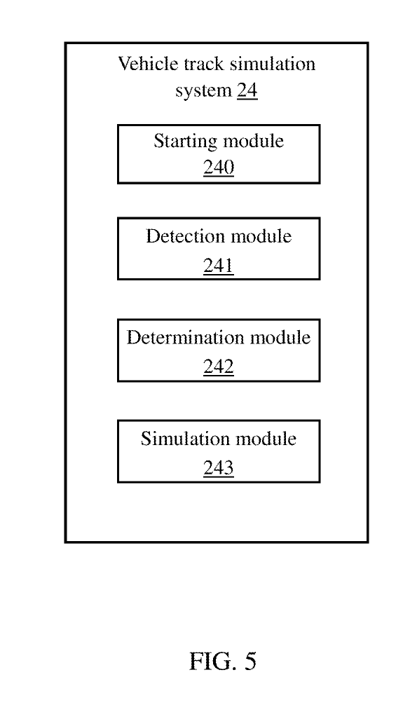

FIG. 5 is a block diagram illustrating function modules of the vehicle track simulation system 24. In this embodiment, the vehicle track simulation system 24 can include a starting module 240, a detection module 241, a determination module 242, and a simulation module 243. The modules 240-243 include computerized code in the form of one or more programs that are stored in the storage device 23. The computerized code includes instructions that are executed by the at least one processor 25 to provide functions of the vehicle track simulation system 24.

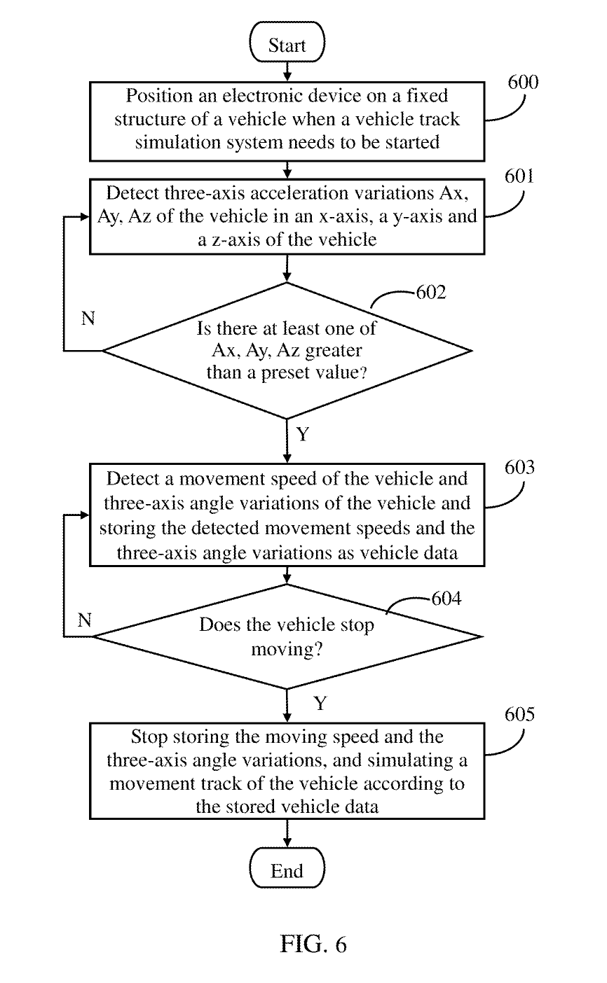

FIG. 6 is a flowchart of one embodiment of a method 600 for adjusting user interface of the handheld device. Depending on the embodiment, additional blocks can be added, others removed, and the ordering of the blocks can be changed. In the embodiment, the method 600 is performed by execution of computer-readable software program codes or instructions by at least one processor of a computing device. The method 600 is provided by way of example, as there are a variety of ways to carry out the method. The method 600 described below can be carried out using the configurations illustrated in FIGS. 1 and 2, for example, and various elements of these figures are referenced in explaining method 600. Each block shown in FIG. 6 represents one or more processes, methods or subroutines, carried out in the method 600. Additionally, the illustrated order of blocks is by example only and the order of the blocks can change according to the present disclosure. The method 600 can begin at block 601.

In block 600, when the handheld device 2 is positioned on the fixed structure 40 in the vehicle 4 and the vehicle track simulation system 24 is started to run, the starting module 240 displays an initial state of a simulated vehicle on the display of the handheld device 2.

In block 601, the detection module 241 detects three-axis acceleration variations of the vehicle 4 using the first sensor 20. The three-axis acceleration variations of the vehicle 4 are determined according to the three-axis acceleration variations along the X-axis, the Y-axis, and the Z-axis of the handheld device 2 based on the preset coordinate system.

In block 602, the determination module 242 determines whether there is at least one of the detected three-axis acceleration variations greater than a preset threshold (for example, 10 m/s²). If all of the detected three-axis acceleration variations are less than or equal to the preset threshold, the procedure returns to block 601. If there is at least one of the detected three-axis acceleration variations greater than the preset threshold, block 603 is implemented. The detected three-axis acceleration variations can determine whether the vehicle 4 is crashed and further determine which direction of the vehicle 4 is crashed.

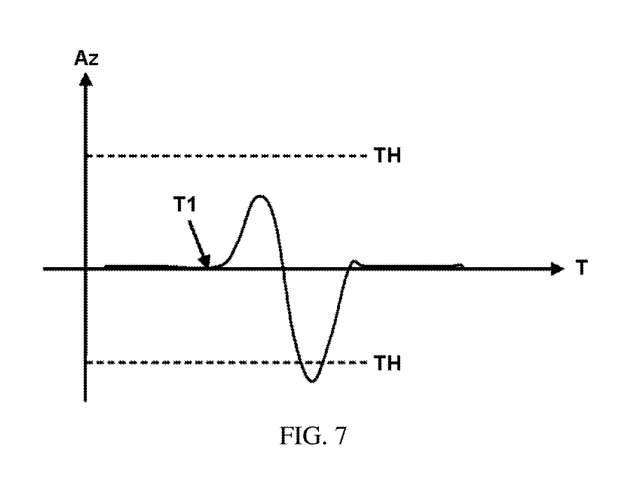

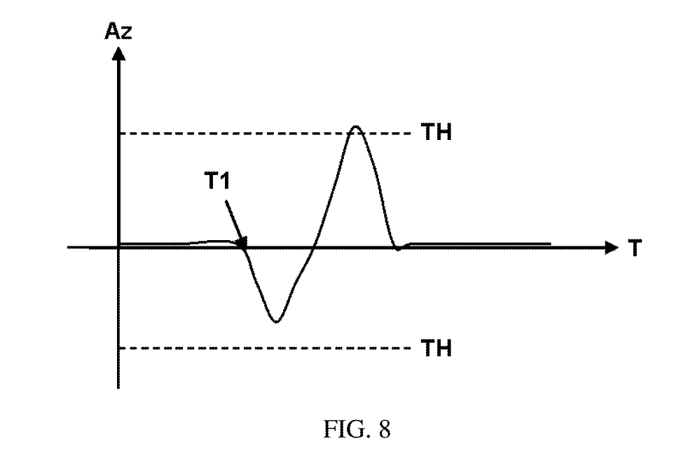

In at least one embodiment, when the vehicle 4 is moving in a uniform motion towards a direction, such as, along the negative orientation of the Z-axis, the acceleration variation “Az” along the Z-axis may almost have no change (e.g. the acceleration variation “Az” before a time period T1 as shown in FIG. 7). If the handheld device 2 is accelerated along negative orientation of the Z-axis, the change of the acceleration variation “Az” may be as shown in FIG. 7 after the time period T1. Therefore, if the vehicle 4 is crashed by another vehicle which is behind of the vehicle 4, the change of the acceleration variation “Az” may occur as shown in FIG. 7. If the vehicle 4 is crashed by one vehicle which is ahead of the vehicle 4, the change of the acceleration variation “Az” may occur as shown in FIG. 8.

In block 603, the detection module 241 detects a movement speed “Gv” of the vehicle 4 using the position system 21, detects three-axis angle variations of the vehicle 4 using the second sensor 22, and stores the detected movement speed and the three-axis angle variations as vehicle data in the storage device 23. The three-axis angle variations of the vehicle 4 are determined according to the three-axis angle variations respectively along the X-axis, the Y-axis, and the Z-axis of the handheld device 2.

In at least one embodiment, when the position system detects the position information and the movement speed of the vehicle 4 at a predetermined time interval (for example, 1 second), the second sensor 22 can detect three-axis angle variations corresponding to the position information and the movement speed at the same predetermined time interval.

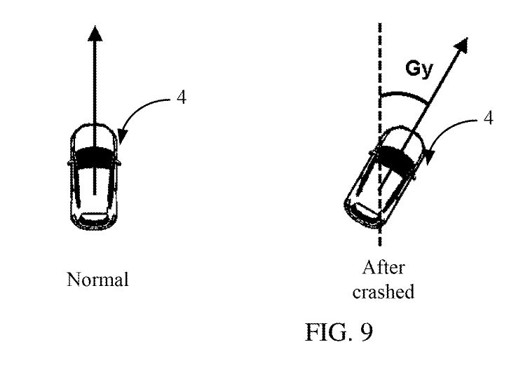

The detection module 241 can determine a movement direction of the vehicle 4 according to the three-axis angle variations. As shown in FIG. 9, after the vehicle 4 is crashed, an angle variation “Gy” is generated. That is, the movement direction of the vehicle 4 generates a deflection of the angle “Gy” based on the Y-axis.

In block 604, the determination module 242 determines whether the vehicle 4 stops moving according to the detected movement speed. If the detected movement speed is less than or equal to a preset speed threshold (for example, 0 Km/h), the determination module 242 determines that the vehicle 4 has stopped moving, and block 605 is implemented. If the detected movement speed is greater than the preset speed threshold, the determination module 242 determines that the vehicle 4 is still moving and the procedure returns to block 603.

In block 605, the simulation module 243 stops storing the detected movement speed and the three-axis angle variations of the vehicle 4, and simulates a movement Track according to the stored vehicle data in the storage device 23. In at least one embodiment, the simulation module 243 obtains a movement displacement “S” using a formula of S=V*t. “V” represents the movement speed and “t” represents a movement time corresponding to the movement speed. The simulation module 243 further obtains a movement direction according to the three-axis angle variations corresponding to the position information and the movement speed. The movement Track is determined according to the obtained movement displacement and the obtained movement direction.

In other embodiments, if there is a tachograph in the vehicle 4, the simulation module 243 further integrates images recorded by the tachograph and the simulated movement Track to provide detailed information for a user.

All of the processes described above may be embodied in, and fully automated via, functional code modules executed by one or more general purpose processors such as the processor 24. The code modules may be stored in any type of non-transitory readable medium or other storage device such as the storage device 23. Some or all of the methods may alternatively be embodied in specialized hardware. Depending on the embodiment, the non-transitory readable medium may be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A handheld device positioned on a vehicle, the handheld device comprising:
at least one processor; and
a storage device storing one or more programs, which when executed by the at least one processor, causes the at least one processor to:
detect three-axis acceleration variations of the vehicle using a first sensor of the handheld device when the vehicle is moving;
detect a movement speed of the vehicle using a position system of the handheld device and detect three-axis angle variations of the vehicle using a second sensor of the handheld device, when at least one of the detected three-axis acceleration variations is greater than a preset threshold;
store the detected movement speeds and detected three-axis angle variations as vehicle data into the storage device; and
stop storing the detected movement speeds and detected three-axis angle variations when the vehicle stops moving, and simulate a movement Track according to the vehicle data stored in the storage device.

2. The handheld device according to claim 1, wherein the detected three-axis acceleration variations of the vehicle are determined according to the three-axis acceleration variations along an X-axis, a Y-axis, and a Z-axis of a preset coordination system of the handheld device, and the three-axis angle variations of the vehicle are determined according to the three-axis angle variations respectively along an X-axis, a Y-axis, and a Z-axis of the handheld device.

3. The handheld device according to claim 1, wherein the position system detects the movement speed of the vehicle at a predetermined time interval and the second sensor detect the three-axis angle variations corresponding to the movement speed at the same predetermined time interval.

4. The handheld device according to claim 1, wherein the movement Track is simulated by:
obtaining a movement displacement “S” using a formula of S=V*t, “V” representing the movement speed and “t” representing a movement time corresponding to the movement speed;
obtaining a movement direction according to the three-axis angle variations corresponding to the movement speed; and
determining the movement Track using the obtained movement displacement and the obtained movement direction.

5. The handheld device according to claim 1, wherein the vehicle is determined to have stopped moving when the movement speed is less than or equal to a preset speed threshold.

6. The handheld device according to claim 1, wherein the at least one processer further displays an initial state of a simulated vehicle on a display of the handheld device when the handheld device is positioned on the vehicle.

7. A method for simulating a movement Track of a vehicle using a handheld device fixed in the vehicle, the handheld device comprising a first sensor and a second sensor, the method comprising:
detecting three-axis acceleration variations of the vehicle using the first sensor when the vehicle is moving;
detecting a movement speed of the vehicle using a position system of the handheld device and detecting three-axis angle variations of the vehicle using the second sensor when at least one of the detected three-axis acceleration variations is greater than a preset threshold;
storing the detected movement speeds and detected three-axis angle variations as vehicle data into a storage device of the handheld device; and
stopping storing the detected movement speeds and detected three-axis angle variations when the vehicle stops moving, and simulating the movement Track according the vehicle data stored in the storage device.

8. The method according to claim 7, wherein the detected three-axis acceleration variations of the vehicle are determined according to the three-axis acceleration variations along an X-axis, a Y-axis, and a Z-axis of a preset coordination system of the handheld device, and the three-axis angle variations of the vehicle are determined according to the three-axis angle variations along an X-axis, a Y-axis, and a Z-axis of the handheld device.

9. The method according to claim 7, wherein the position system detects the movement speed of the vehicle at a predetermined time interval and the second sensor detect the three-axis angle variations corresponding the movement speed at the same predetermined time interval.

10. The method according to claim 7, wherein the movement Track is simulated by:
obtaining a movement displacement “S” using a formula of S=V*t, “V” representing the movement speed and “t” representing a movement time corresponding to the movement speed;
obtaining a movement direction according to the three-axis angle variations corresponding the movement speed; and
determining the movement Track using the obtained movement displacement and the obtained movement direction.

11. The method according to claim 7, wherein the vehicle is determined to have stopped moving when the movement speed is less than or equal to a preset speed threshold.

12. The method according to claim 7, wherein the method further comprises displaying an initial state of a simulated vehicle of the vehicle on a display of the handheld device when the handheld device is positioned in the vehicle.

13. A non-transitory storage medium having stored thereon instructions that, when executed by at least one processor of a handheld device, cause the processor to perform a method for simulating a movement Track of a vehicle using the handheld device fixed in the vehicle, the handheld device comprising a first sensor and a second sensor, the method comprising:
detecting three-axis acceleration variations of the vehicle using the first sensor when the vehicle is moving;
detecting a movement speed of the vehicle using a position system of the handheld device and detecting three-axis angle variations of the vehicle using the second sensor when at least one of the detected three-axis acceleration variations is greater than a preset threshold;
storing the detected movement speeds and detected three-axis angle variations as vehicle data into a storage device of the handheld device; and
stopping storing the detected movement speeds and detected three-axis angle variations when the vehicle stops moving, and simulating the movement Track according the vehicle data stored in the storage device.

14. The non-transitory storage medium according to claim 13, wherein the detected three-axis acceleration variations of the vehicle are determined according to the three-axis acceleration variations respectively along an X-axis, a Y-axis, and a Z-axis of a preset coordination system of the handheld device, and the three-axis acceleration variations of the vehicle are determined according to the three-axis acceleration variations respectively along an X-axis, a Y-axis, and a Z-axis of the handheld device.

15. The non-transitory storage medium according to claim 13, wherein the position system detects the movement speed of the vehicle at a predetermined time interval and the second sensor detect the three-axis angle variations corresponding the movement speed at the same predetermined time interval.

16. The non-transitory storage medium according to claim 13, wherein the movement Track is simulated by:
obtaining a movement displacement “S” using a formula of S=V*t, “V” representing the movement speed and “t” representing a movement time corresponding to the movement speed;
obtaining a movement direction according to the three-axis angle variations corresponding the movement speed;
determining the movement Track using the obtained movement displacement and the obtained movement direction.

17. The non-transitory storage medium according to claim 13, wherein the vehicle is determined to be stopped moving when the movement speed is less than or equal to a preset speed threshold.

18. The non-transitory storage medium according to claim 13, wherein the method further comprises displaying an initial state of a simulated vehicle of the vehicle on a display of the handheld device when the handheld device is positioned on a fixed structure in the vehicle.
